(19) United States
(12) Patent Application Publication
(10) Pub. No.: US 2004/0030637 A1
(43) Pub. Date: Feb. 12, 2004

(54) Method for conducting electronic commerce

(76) Inventors: Sharon K. Robison, Julesburg, CO (US); David A. Roehr, Sidney, NE (US)

Correspondence Address: Barry L. Kelmachter, BACHMAN & LaPOINTE, P.C., Suite 1201, 900 Chapel Street, New Haven, CT, 06510-2802, US

(21) Appl. No.: 10/217,671

(22) Filed: Aug. 12, 2002

(51) Int. Cl. G06F 17/60

(52) U.S. Cl. 705/38

(57) ABSTRACT

The present invention relates to a method for conducting electronic business. The method comprises the steps of providing a web site for a consumer to purchase at least one of goods and services; receiving personal information about the consumer as the consumer processes a form to make a purchase transaction; transmitting the personal information to at least one credit bureau; receiving a signal representative of the creditworthiness of the consumer; and making an offer for credit to the consumer on the web site during the purchase transaction if the creditworthiness exceeds a particular threshold.

### BACKGROUND OF THE INVENTION

The present invention broadly relates to electronic commerce and more particularly to a method for offering credit to a customer during an online business transaction.

Consumers frequently receive offers for credit cards. These offers typically are made via unsolicited mail or telephone contacts. Many of the credit cards being offered have some affiliation with a business such as an airline, a sports team, a hotel chain, or a retail business. Other credit cards have affiliations with universities and other institutions. These affiliated cards are intended to enhance the loyalty between a consumer and a particular entity. However, the costs associated with making these offers often outweighs the benefits since only few people actually accept such credit card offers.

Some businesses, as part of a strategy to increase the acceptance of loyalty credit card offers, have developed techniques for making credit offers during a telephone transaction when a consumer is making a purchase via telephone. In these techniques, credit checks are carried out in relatively short periods of time while the consumer is on the telephone making the purchase. If the consumer passes the credit check, a credit offer is made to the consumer while the consumer is on the telephone. The consumer then has the option of accepting the credit offer or declining same. If the consumer does not pass the credit check, then no offer is made to the consumer and the consumer has no knowledge that a credit check has occurred.

Recognizing the need for quick credit checks, systems have been developed for carrying out such credit checks. One such system for real time credit approval is shown in published U.S. patent application No. 20020007341 to Lent.

In the past few years, electronic commerce on the Internet has grown. Today, many large businesses have web sites through which consumers can purchase goods and/or services. A typical Internet business transaction allows the consumer to view the goods/services being offered by the business, select the goods/services to be purchased, and then proceed to a check-out screen. At the check-out screen, the consumer typically enters contact/shipping information, i.e. name, address, and telephone number, and his/her credit card number, at least during the first time he/she purchases goods from the business via the web site. These business transactions are an opportunity for businesses to create a further affiliation between the consumer and the business. However, to date, no one has availed themselves of these opportunities.

### SUMMARY OF THE INVENTION

Accordingly, it is an object of the present invention to provide a method for conducting electronic commerce which has potential to enhance the relationship between a consumer and a business.

It is a further object of the present invention to provide a method as above which offers credit to a consumer while he/she is online to further the relationship between the consumer and the business.

It is a further object of the present invention to provide a method as above which offers a credit card and/or other loyalty rewards associated with a business' loyalty program to a consumer online during a business transaction.

The foregoing objects are attained by the method of the present invention.

In accordance with the present invention, a method for conducting business broadly comprises the steps of: providing a web site through which a consumer can purchase at least one of goods and services; receiving personal information about the consumer when the consumer processes an order form to consummate a purchase transaction; transmitting the personal information to at least one credit bureau; receiving an indication from the at least one credit bureau as to the creditworthiness of the consumer; and making an offer for credit to the consumer during the purchase transaction if the consumer is creditworthy. The offer for credit may take the form of a credit card tied to the business' loyalty program. In addition to the credit card offer, the consumer may be offered additional benefits such as membership in the loyalty program and points to be used in connection with the loyalty program.

Other details of the method for conducting electronic commerce of the present invention, as well as other objects and advantages attendant thereto, are set forth in the following detailed description and the accompanying drawing(s) wherein like reference numerals depict like elements.

### BRIEF DESCRIPTION OF THE DRAWING(S)

FIGS. 1A and 1B are flow charts for performing the electronic commerce method of the present invention.

### DETAILED DESCRIPTION OF THE PREFERRED EMBODIMENT(S)

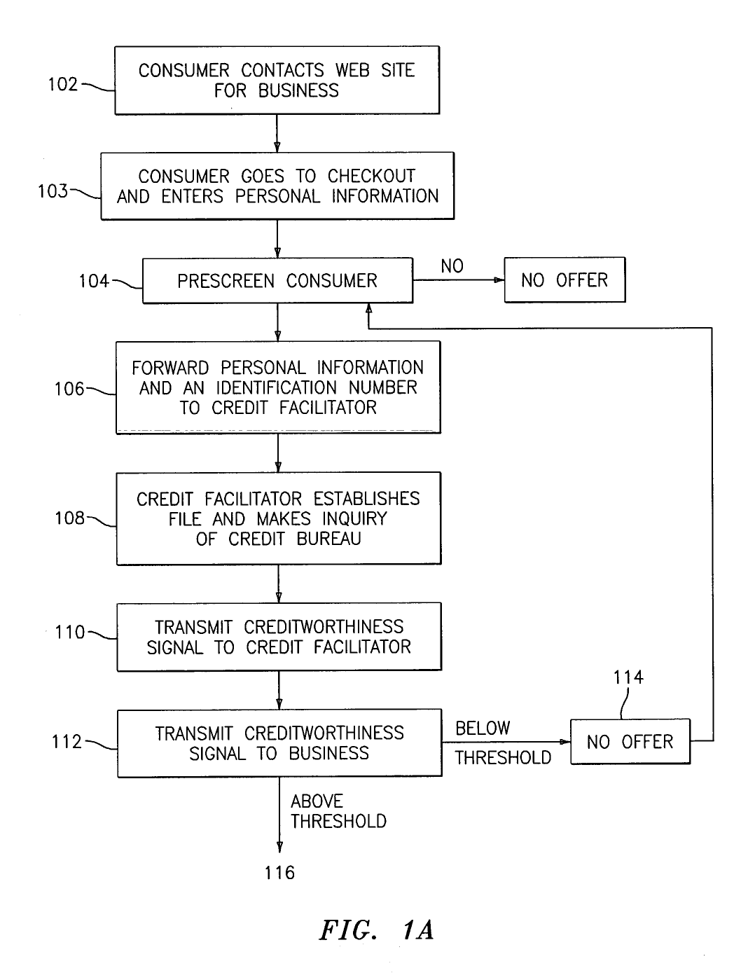

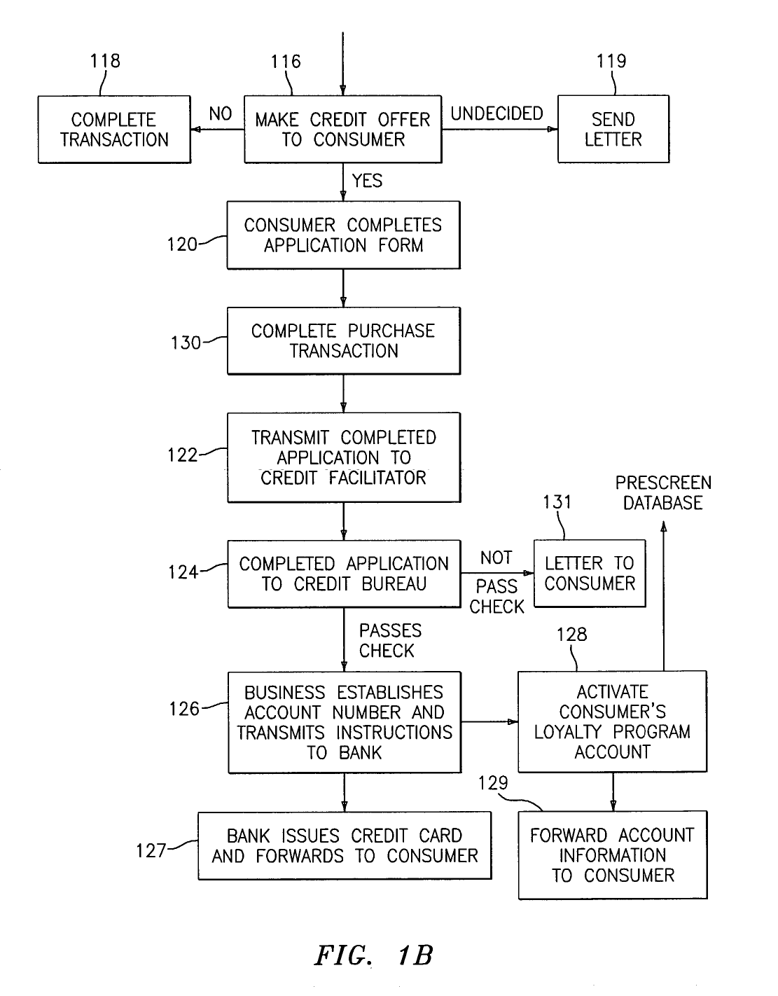

Referring now to FIGS. 1A and 1B, a method for conducting electronic commerce is illustrated. The method begins in step 102 where the customer, using a computer, establishes contact via the Internet with a web site operated by the business. The web site contains, amongst other things, goods and/or services being sold by the business. As the consumer reviews the goods and services on the web site and makes his/her selections, the selections may be placed in a virtual shopping cart in a known manner. After all selections have been made, the consumer is directed to a checkout screen, an order form screen, or the like in step 103. When the consumer arrives at this screen, the consumer is directed to enter certain personal information about the order. This personal information may include the consumer's name, current address, telephone number, and other information.

In step 104, the consumer is screened to determine whether he/she is eligible to receive an offer for credit. During this step, the personal information entered by the consumer is automatically checked against a consumer database operated by the business without the intervention of the operator and without an operator of the system having to enter any keystrokes. The database may be located on the computer hosting the web site or may be located on a different computer. If the database is located on another computer, the personal information may be transferred by a high speed connection to the database computer. The computer hosting the database is programmed to determine the eligibility of the consumer. The database may be updated periodically, such as weekly, to make sure that current information is available during the eligibility check. In this step, the consumer may be found to be ineligible because he/she made a purchase within a particular period of time and/or because he/she did not respond to a previous credit offer. Alternatively, the consumer may be ineligible because he/she already has a credit card sponsored by the business or is a current member of a loyalty program sponsored by the business. Still further, the consumer may be ineligible because he/she has declined prior credit offers or has perpetrated some fraud against the business or some other entity, i.e. providing incorrect personal information. Any filtering scheme may be used to determine whether the consumer should be made an offer for credit. If the consumer is found to be ineligible, no credit offer is made to the consumer.

If the consumer passes the initial screen, the personal information entered by the consumer as well as an identification number assigned by the business, is electronically forwarded to a credit facilitator as shown in step 106 over a high speed line. The identification number may be assigned automatically by the computer hosting the web site or may be assigned by an operator of the computer hosting the web site. The credit facilitator electronically sets up an initial file for the consumer and electronically transmits the personal information to one or more credit bureaus as shown in step 108 also over a high speed line. The credit bureau(s) receive the personal information, and electronically check their records to determine a creditworthiness score for the consumer. The creditworthiness score is compared to a minimum threshold level and a signal representative of the creditworthiness of the consumer is transmitted to the credit facilitator in step 110 who, in turn, transmits the signal to the business in step 112. The transfer of information to the credit facilitator and to the credit bureau and the transmission of the creditworthiness signal from the credit bureau to the credit facilitator and to the business typically takes 5 seconds or less. Thus, in real-time, a decision can be made whether to extend a credit offer to the consumer. As shown in step 114, if the creditworthiness score is below a threshold value, no credit offer is made to the consumer. As part of this step, the customer's name and other personal information may be entered as a “no credit” into the database maintained by the business and used to prescreen consumers in step 104. If the creditworthiness score is above the threshold value, a credit offer is made to the consumer as shown in step 116.

The credit offer to be made to the consumer in step 116 may be the offer of a credit card sponsored by the business. The offer may be made on screen and the consumer may have the option to say “yes”, “no”, or “undecided” to the offer. In addition to, or in lieu of, offering the credit card, the business may offer other incentives to the consumer. For example, the business may offer membership in a loyalty program operated by the business. Further, the consumer may be offered a certain number of points in the loyalty program which may be redeemed against future purchases of goods and/or services or other future awards and be awarded additional points for the order that he/she is placing.

If the consumer says no to the credit card offer and/or the other incentives by inserting a check mark or an “x” in a box labeled “NO” which appears on the computer screen, the transaction may be completed as shown in step 118 by the consumer inputting into the order form, check out screen, or the like, a valid credit card number having sufficient credit to pay for the purchased goods and/or services.

If the consumer says yes to the credit offer by checking or placing an “x” in a “YES” box which appears on the computer screen, another screen will appear with a more detailed credit card application form for the consumer to complete while online. This is shown in step 120. After the consumer has completed the credit card application, the current business transaction may be completed by accepting payment either through another credit card or through the credit card to be issued to the consumer. This is shown n step 130.

If the consumer is “on the fence” and is not prepared to make a decision during the current transaction, the consumer may place a check mark or an “x” in an “UNDECIDED” box which appears on the screen. If the consumer electronically checks this box, a follow-up letter with an invitation to join the customer loyalty program operated by the business and/or a credit card associated therewith is forwarded to the consumer as shown in step 119.

While the current business transaction is being completed, the completed credit application is electronically transmitted to the credit facilitator as shown in step 122 again without any intervention by a system operator. The credit facilitator matches the application with the file already established for the consumer and electronically transmits the completed application to the credit bureau as shown in step 124. The credit bureau now runs a more detailed credit check on the consumer and issues a credit report concerning the creditworthiness of the consumer. The credit report typically shows that the consumer has or has not passed a certain creditworthiness score or level. The credit report may also contain a recommended credit line for the consumer. If the credit report is acceptable to the business, the business establishes an account number for the consumer in its database and transmits instructions and other information, as shown in step 126, to a bank who has the credit card issued and activated and forwarded to the consumer in step 127. The instructions may include a credit line for the consumer and his/her account number amongst other things. The information to be electronically transferred may include the consumer's name, address, telephone number, etc.

As shown in step 128, the business activates the consumer's new account in its loyalty award program and updates the prescreen database. Appropriate points for the order which has been placed as well as bonus or signing points are credited to the account. Further, the consumer is notified of his/her new loyalty award program account number in step 129. Loyalty program indicia such as a membership card may be forwarded to the consumer. Additionally, a web site may be operated which allows the consumer to access his/her account and determine its status.

If the credit report is not acceptable to the business, as shown in step 131, a letter is forwarded to the consumer informing him/her that a credit card will not be forthcoming.

While the method of the present invention has been described in the context of there being a credit facilitator through which information is transferred from the business to the credit bureau and vice versa, the credit facilitator may be omitted if desired. In such a case, the business may deal directly with the credit bureau(s).

The above method for conducting electronic commerce may be used by a wide variety of business offering a wide variety of goods and/or services. For example, the method of the present invention could be used by retail stores having web sites, catalog businesses, travel agents, airlines, hotel chains, on-line businesses, sports teams, etc.

It is apparent that there has been provided in accordance with the present invention a method for conducting electronic commerce which fully satisfies the objects, means and advantages set forth hereinbefore. While the present invention has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

What is claimed is:

1. A method for conducting commercial business comprising the steps of:
providing a website for a consumer to purchase at least one of goods and services;
receiving personal information about the consumer when the consumer processes an order form to making a purchase transaction;
transmitting said personal information to at least one credit bureau;
receiving a signal as to the creditworthiness of the consumer; and
making an offer for credit to said consumer on said website during said purchase transaction if said creditworthiness exceeds a particular threshold.

2. A method according to claim 1, wherein said credit offer making step comprises offering a credit card to said consumer.

3. A method according to claim 2, wherein said credit offer making step further comprising offering bonus points in a loyalty program to said consumer if said consumer accepts said credit card offer.

4. A method according to claim 1, further comprising determining the eligibility of said consumer to receive a credit offer prior to said personal information transmitting step.

5. A method according to claim 4, wherein said eligibility determining step comprises comparing said personal information to information in a database and determining whether the consumer is disqualified.

6. A method according to claim 1, wherein said transmitting step comprises transmitting said personal information to said at least one credit bureau via a credit facilitator.

7. A method according to claim 6, wherein said credit facilitator receives said personal information and an identification number from said business prior to said transmitting step.

8. A method according to claim 6, wherein said receiving step comprises electronically transmitting one of an approval signal and a non-approval signal to said business via said credit facilitator.

9. A method according to claim 1, further comprising said consumer completing a credit card application form if said consumer-accepts said credit offer.

10. A method according to claim 9, further comprising completing said purchase transaction after said consumer has completed said credit card application form.

11. A method according to claim 9, further comprising transmitting said completed credit card application form to said at least one credit bureau for a further credit check.

12. A method according to claim 11, wherein said transmitting step comprises transmitting said completed credit card application to said at least one credit bureau via a credit facilitator.

13. A method according to claim 11, further comprising said business establishing a credit card account for said consumer if said consumer passes said credit check.

14. A method according to claim 13, further comprising activating a loyalty program account for said consumer and passing said loyalty program account information to a database used to prescreen said consumer.

15. A method according to claim 14, further comprising informing said consumer of said loyalty program account.

16. A method according to claim 13, further comprising instructing a banking institution to issue a credit card to said consumer.
